(19) United States
(12) Patent Application Publication
(10) Pub. No.: US 2009/0151395 A1
(43) Pub. Date: Jun. 18, 2009

(54) INTERCHANGEABLE RING SYSTEM JEWELRY

(76) Inventors: Nir Louk, Beit Shemesh (IL); Efrat Fridenzon, Beer Yaakov (IL)

Correspondence Address: NIR LOUK, HEMEK HAZEITIM 123/1, BEIT SHEMESH, 99034, IL

(21) Appl. No.: 11/955,200

(22) Filed: Dec. 12, 2007

(51) Int. Cl. A44C 9/00; B23P 13/00

(52) U.S. Cl. 63/15.1; 29/8

(57) ABSTRACT

An interchangeable ring system jewelry (20) consisting of a custom ring assembly (18) which can be assembled according to the user's desire, manually or by using specific tools (28L, 28R). The custom ring assembly (18) is comprised of an elongated flanged ring shank (22), an inner threaded nut-like interlocking ring (26), and an interchangeable inner ring (24).

The flanged ring (22) in its preferred configuration is comprised of a fixed flange ring (36), fixed to one of its ends, and an external thread (32) on the other end.

The inner ring (24) is slid onto the flanged ring shank (22), up to the fixed flange ring (36).

The interlocking ring (26) interlocks to the flanged ring shank (22), screwed to its threaded end using specific tools (28L, 28R) or manually.

In this way, the inner ring (24) is delimited between the interlocking ring (26) and the fixed flange ring (36) of the flanged ring shank, creating ready-to-wear custom ring jewelry.

### CROSS-REFERENCE TO RELATED APPLICATIONS

Not Applicable

### BACKGROUND OF THE INVENTION

The present invention relates to the ring jewelry industry, specifically to the field of ring jewelry that comprises elements that are interchangeable by the user.

The user is rarely a part of the design and creation process of the jewelry nor can the user change elements affecting the appearance of the jewelry after it's been created. Interchangeable jewelry provides a possibility for the user to become a part of the creation and design process. Interchangeable jewelry allows the user to change, update or “mix and match” elements in the jewelry, thus adding interest to the jewelry in every use.

Furthermore, the jewelry's assembly and disassembly itself adds enjoyment and a source of pleasure.

U.S. Pat. No. 5,456,095 Tawil et. al. (1995), U.S. Pat. No. 5,588,310 Lai (1996), U.S. Pat. No. 5,375,434 Wertheimer et. al. (1994), U.S. Pat. No. 4,905,482 Gheblikian (1990), and U.S. Pat. No. 4,977,757 Mesica et. al. (1990) focus on the interchangeability of a ring's gemstones, settings and other types of topical ornamentation, and do not provide an interchangeability solution for rings without any gemstones or topical ornaments, which are very common in the ring design industry.

In this vast section of the ring-jewelry industry, customers see the ring itself as the main ornament, even without gemstones, settings or any topical ornaments, as can be seen in numerous main stream ring-jewelry designs. Examples of such designs are U.S. Pat. No. 7,181,930 Wainberg (Feb. 27, 2007), BVLGARI design-model B.ZERO1 (internet website: http://www.bvlgari.com, (English version website), under menu jewels/collections/B.ZERO1).

In prior art, the mechanisms which permitted elements to be interchanged were mechanically complicated, i.e., including clamp hooks, latches and hinges, for example U.S. Pat. No. 4,794,766 Schunk et. al. (1989) and U.S. Pat. No. 6,715,314 Rose (2004).

Prior art such as U.S. Pat. No. 6,490,886 Steinhauer et. al. (2002), U.S. Pat. No. 4,374,470 Isaacson (1983) and U.S. Pat. No. 5,491,986 White (1996) use small rotating levers, hinged doors and other numerous tiny parts.

These patents present various complex methods of interlocking the different elements of the jewelry, thus the interlocking mechanism still appears intimidating to the user, although claiming to be user-friendly.

Prior art in the field of interchangeable ring jewelry suffers from various drawbacks:

(a) Does not provide the option to change the design of the ring itself when gemstones, settings or topical ornaments are not a part of the ring's design. This need exists mainly in the field of men's rings.

(b) Lacks ability to interchange rings in the assembly with existing rings, not only with elements designed specifically for the invention (rings the user may already have or rings that may be purchased irrespective of the present invention).

(c) Uses unduly complicated mechanisms which fall short of providing interchangeability in a simple and obvious mechanical way. Prior art interchangeability mechanisms are not always self-explanatory and therefore can be highly intimidating to the user.

(d) Having unsightly aesthetic impact at the expense of interchangeability, as it is difficult to provide an interchangeability mechanism that is hidden from view.

(e) Having insecure interlocking mechanisms due to use of small and delicate handcrafted moving elements, instead of a simple, machine-made interlocking mechanism that is less vulnerable to failure.

(f) Significantly increased cost of manufacturing due to use of complicated interlocking mechanisms made of tiny moving elements, hence creating the need for costly professional hand crafting. For example U.S. Pat. No. 4,742,696 Jenkins (1988) and U.S. Pat. No. 5,077,989 Dillabaugh (1992).

(g) The use of hand made elements limits the option to use hard metals (such as titanium) that are commonly used in the jewelry industry.

(h) Lacks ability to select and determine the overall width of the ring assembly.

### BRIEF SUMMARY OF THE INVENTION

The interchangeable nature of the ring system jewelry detailed in the present patent application allows the jewelry wearer to assemble unique custom ring jewelry, with or without a topical ornament, according to their desires (e.g., personal taste or mood, outfit being worn, color coordination, event being attended, etc.).

Interchangeability is achieved by using a simple, easy to use, affordable and durable interlocking mechanism, providing great pleasure and freedom of personal creativity.

The present invention provides at least one interchangeable ring, an inner ring, which slides onto a flanged ring shank, an elongated cylinder-like shank having a delimiting flange ring fixed to one of its ends.

A second delimiting ring interlocks via an interlocking mechanism (e.g. screwing) to the second end of the elongated shank, thus delimiting and retaining the interchangeable inner ring encircling the shank. The inner ring is sandwiched between the fixed flange ring and the interlocking ring, preventing it from sliding off the shank.

The result is a closed custom ring assembly which looks like any other fashionable, non-interchangeable ring jewelry, commonly found in the jewelry market these days.

Operating of the interlocking mechanism can be done in a simple manual way, or by using a special set of specific tools if provided as part of the present invention.

These specific tools engage with the delimiting rings, providing better grip and control over the ring assembly, thus aiding in the process of interlocking or releasing the interlocking ring to or from the flanged ring shank.

In correlation with the existing demands in the jewelry market for interchangeable ring jewelry, some objects and advantages of the present invention are:

(a) to provide interchangeability of designed rings as a part of a custom ring assembly according to the user's desire. These rings can be with or without any topical ornament;

(b) to provide the possibility to interchange an inner ring with any existing ring or rings that the user may already have, and not especially built for the present invention, as long as it is within the ring assembly's size limitations of width and inner diameter;

(c) to provide a simple, intuitive and not intimidating interlocking mechanism to simplify the interchanging process for the jewelry wearer and to ease its handling;

(d) to provide a simple and obvious interlocking mechanism (such as thread) that is hidden from ordinary view, with no aesthetic impact as an expense for interchangeability;

(e) to provide a simple, secure and reliable interlocking mechanism (such as thread), to obliterate the use of small handcrafted moving parts that are vulnerable to failure;

(f) to provide a simple interlocking mechanism (such as thread) to enable simple manufacturing by existing industrial milling or CNC machinery, thus lowering costs of production, and as a result, lowering the cost of the jewelry;

(g) to enable use of existing industrial milling or CNC machinery for creating all of the present invention's elements, thus enabling the use of any desired metal and not limited to relatively soft metals commonly used in hand-made jewelry;

(h) to provide the ability to change and control the width of the ring assembly, thus determining the number of the interchangeable inner rings in the assembly;

(i) to provide an option to use specific tools for operating the interlocking mechanism in order to augment the user's participation in the ring's design and creation, to add interest and pleasure in handling the interlocking mechanism and to more firmly secure the elements of the ring assembly; and

(j) to provide an option to “mix and match” any elements belonging to different custom ring assemblies, as long as they are compatible in size and in the interlocking mechanism.

The invention will be best understood by reference to the following detailed description and in conjunction with the accompanying figures.

### BRIEF DESCRIPTION OF THE SEVERAL VIEWS OF THE DRAWING

FIG. 1 shows a perspective exploded view of the interchangeable ring system jewelry that is ready for assembly;

FIG. 2 shows a perspective view of a complete custom ring assembly, fully assembled and ready-to-wear;

FIG. 3A shows a perspective view of a flanged ring shank, its corresponding specific tool and an inner ring;

FIG. 3B shows a perspective view of an interlocking ring and its corresponding specific tool;

FIG. 4 shows a perspective view of an alternative structural design of an interlocking ring and its corresponding specific tool; and

FIG. 5 shows a perspective view of an open-state custom ring assembly in a different configuration, using a set of inner rings encircling a cylinder-like shank member and two interlocking rings.

### DETAILED DESCRIPTION OF THE INVENTION

In accordance with the present invention, for a better and more accurate description, the following definitions are provided:

(a) Delimiting Rings—At least two delimiting rings exist in the present invention; each one encircling one end of a cylinder-like shank, prevents sliding of encircling ring or rings from the cylinder-like shank;

(b) Interlocking Mechanism—means for securing or releasing at least one of the delimiting rings to or from either cylinder-like shank end (for example: screwing, magnet, pressure, etc.);

(c) Specific Tools—Specially built tools used to operate the interlocking mechanism by engaging with the delimiting rings;

(d) Engaging Structure—a specific structure of protruding or indented elements, holes etc., situated on a specific tool and correspond to a mating Engaging Structure on a delimiting ring; enables engagement or enhancing of friction between a specific tool and its corresponding delimiting ring;

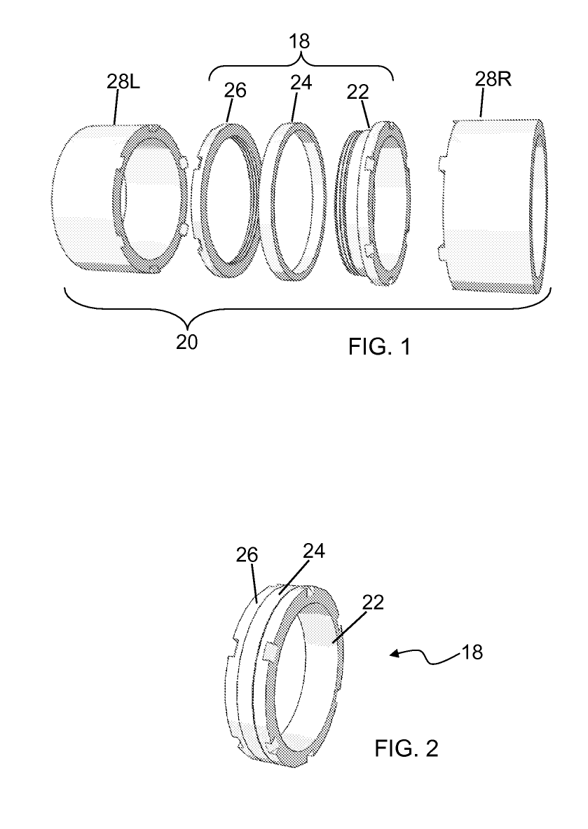

The present invention, an interchangeable ring system jewelry (20), in its preferred configuration is depicted in FIG. 1.

The interchangeable ring system jewelry (20) is comprised of a custom ring assembly (18), and specific tools (28L, 28R).

The preferred configuration as depicted in FIG. 1 is comprised of an elongated flanged ring shank (22), an internally-threaded nut-like interlocking ring (26), an interchangeable inner ring (24) and specific tools (28L, 28R).

In this configuration, the flanged ring (22) and the interlocking ring (26) are interlocked using a thread, thus sandwiching the inner ring (24) between them.

All elements in the ring system are preferably made from, but not limited to, metals that are commonly used in the jewelry industry (i.e. gold, titanium, silver etc.)

Note the simplicity of the system and the obvious method of assembly.

FIG. 2 depicts a fully assembled and ready-to-wear custom ring assembly (18) in its preferred configuration, comprised of the flanged ring shank (22), the inner ring (24) and the interlocking ring (26).

It should be noted that the interlocking mechanism (thread) is not visible in this fully assembled state.

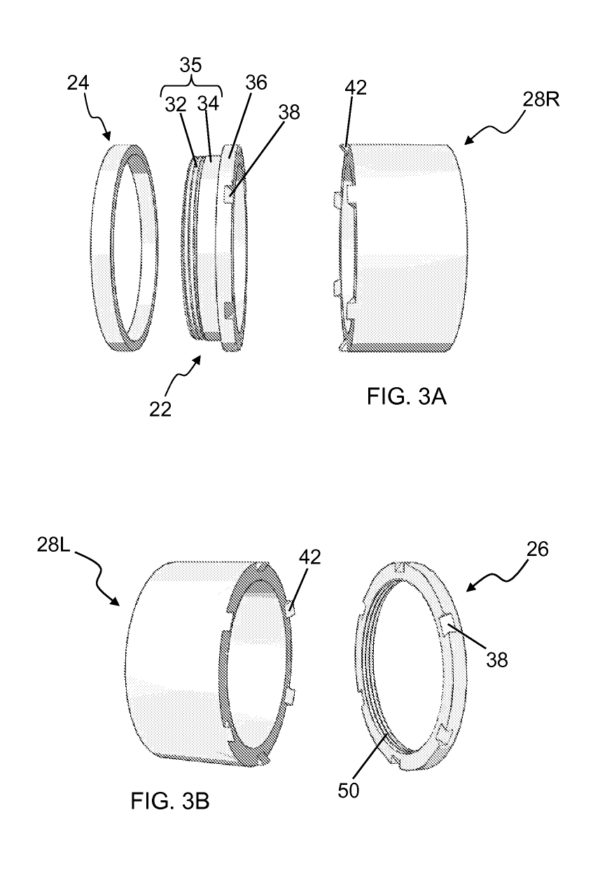

FIG. 3A depicts a detailed perspective view of the flanged ring shank (22), its corresponding specific tool (28R) and the inner ring (24).

Referring to FIG. 3A, the flanged ring shank (22) is constructed from an elongated cylinder-like shank (35) having a fixed flange ring (36) at its first end;

The elongated shank (35) is comprised of two different structural cylindrical sections:
(a) An inner seating (34) is the first section of the shank (35), having the flange ring (36) at one of its ends;
(b) An external thread (32) is the second section of the shank (35).

FIG. 3B depicts a detailed perspective view of the interlocking ring (26) and its corresponding specific tool (28L); the interlocking ring (26) is the second of two delimiting rings which exist in the ring system (20), along with the flange ring (36);

Referring to FIG. 3A and FIG. 3B, the inner diameter of the inner ring (24) should be smaller than the outer diameter of the delimiting rings (26, 36), and should be bigger than the outer diameter of the shank (35), hence providing the ability for the inner ring (24) to slide over the shank (35), and to sit on the inner seating (34).

Referring to FIG. 3A and FIG. 3B, the interlocking ring (26) has an internal thread (50) through which it connects to its mating external thread (32) of the flanged ring shank (22).

Regarding the two delimiting rings (26, 36) depicted in FIG. 3A and FIG. 3B, a ring engaging structure (38) of indents, corresponding to a mating tool engaging structure (42) of protruding elements on their corresponding specific tools, enable engagement and enhancing of friction between the two delimiting rings (26, 36) and their corresponding specific tools (28L, 28R); The specific tools (28L, 28R) are built in a predetermined sufficient size to provide a firm grip by the user's fingers, and thus easier control over the ring assembly while operating the interlocking mechanism.

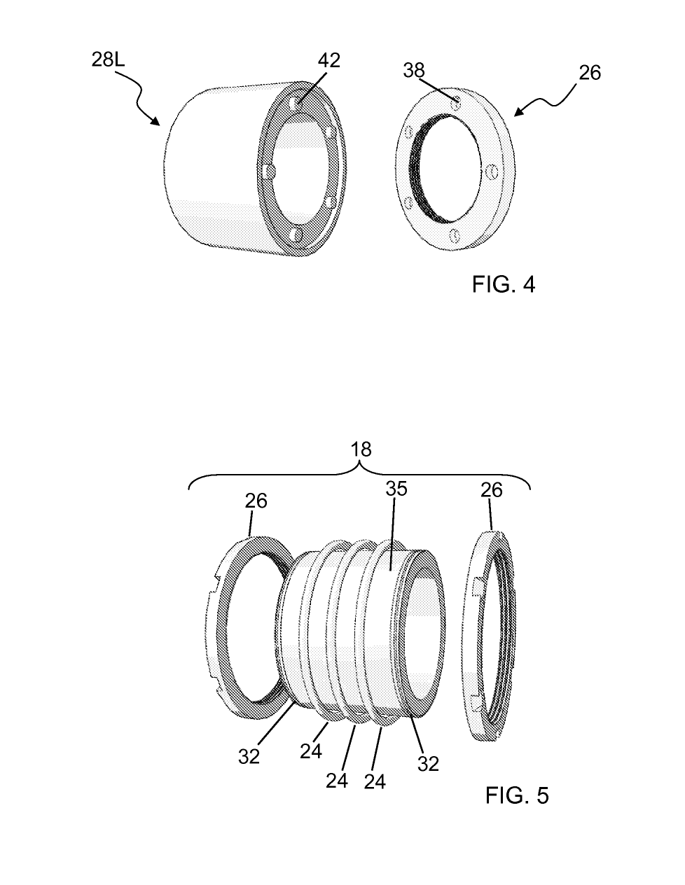

FIG. 4 depicts an alternative structural design of an interlocking ring (26) and its corresponding specific tool (28L).

Referring to FIG. 3B and FIG. 4, two unique ring engaging structures (38) and their mating tool engaging structures (42) are depicted; these configurations depict a number of angled rectangular indents or circular holes on the interlocking ring (26) into which fit an equal number of corresponding protrusions on the specific tool (28L).

Engaging structures are not limited in their shapes, design or material, as long as they will enable engagement and enhancing of friction between a delimiting ring and a specific tool, thus providing a firm grip and control over the ring assembly while handling the interlocking mechanism.

The custom ring assembly (18) in its preferred configuration is assembled using the following method:

Interchangeable inner ring (24), which can be any existing ring in a predetermined size, is slid onto the shank (35) of the flanged ring (22). It is positioned on the inner seating (34) between the fixed flange ring (36) of the flanged ring, and the external thread (32).

The interlocking ring (26) screws onto the external thread (32) of the flanged ring, up to the edge of the flanged ring's inner seating (34).

This construction enables sandwiching of the inner ring (24), upon the inner seating (34) of the flanged ring, between the interlocking ring (26) and the fixed flange ring (36) of the flanged ring.

For interesting handling and a more controlled grip, specific tools (28L, 28R) correspondingly engage with the delimiting rings (26, 36) and provide stronger securing and easier releasing of the interlocking ring (26) to or from the flanged ring (22).

In a case where there are no specific tools as part of the ring system (20), operating the interlocking mechanism may be done manually.

In the ring assembly preferred configuration as previously depicted (FIG. 1), when using the flanged ring shank (22), the amount of inner rings (24) that can be used in the assembly is determined by the length of the inner seating (34).

Referring to FIG. 5, a different configuration of a custom ring assembly (18) is depicted, using an elongated shank (35) of some length, without a fixed flange ring on one of its ends.

using various lengths of shanks (35) enables width variation of the ring assembly (18), thus varying the number of inner rings (24) that can be used.

The inner ring or rings (24) are slid onto the elongated shank (35) which is delimited from both sides by two interlocking rings (26).

The two interlocking rings (26) are both screwed onto the threaded ends (32) of the elongated shank (35).

Referring to FIG. 5, handling the interlocking mechanism of this alternative ring assembly (18) can be done manually or by using specific tools (28L, 28R), in the same manner as using them with the preferred ring assembly previously depicted (FIG. 1).

### Conclusion and Scope of Invention

While the above description contains many specifications, these should not be construed as limitations on the scope of the invention, but rather as an exemplification of preferred configurations thereof. For example:

(a) Any part of the present invention may or may not contain gemstones.

(b) Any part of the present invention may consist of various materials (gold, silver, titanium, etc.), possibly with some kind of design element present (e.g. texture, pattern, color, etc.)

(c) The interlocking mechanism can be any means that provides short-term but secure interlocking of the interlocking ring (26) to the external thread (32) of the flanged ring (22). (This means can be, but is not limited to, magnet, snap closure or thread).

(d) Depending on the predetermined length of the elongated shank (35) and the width of the inner rings (24) used, a plurality of inner rings can be used in the ring assembly.

(e) The engaging structure can be of any structure or material as long as it will enhance friction between the specific tools and the delimiting rings (26, 36), thus easing the operation of the interlocking mechanism.

(f) The general structure of the interchangeable ring system jewelry (20) and its elements may or may not be round. A use of any other cross sectional shapes for the assembly members is possible, as long as it will enable a ring to slide and to be positioned onto a shank member in between two rings which encircle both ends of the shank member, and as long as it will enable the assembled ring assembly to slide onto a finger;

What we claim as our invention is:

1. An interchangeable ring system jewelry comprising of a ring assembly comprising of
an interchangeable inner ring, having predetermined inner diameter,
a flanged ring shank, with sufficient inner diameter that defines a finger receiving opening, built as
an elongated cylinder-like shank, having outer diameter smaller than the inner diameter of said inner ring, and
a fixed flange ring, fixed to first of two ends of said elongated shank, having outer diameter bigger than the inner diameter of said inner ring,
an interlocking ring, having outer diameter bigger than the inner diameter of said inner ring,
an interlocking means for temporarily interlocking said interlocking ring with the second end of said elongated shank,
said inner ring slides onto said elongated shank, said interlocking ring interlocks with the second end of said shank, thus delimiting said inner ring between said fixed flange ring and said interlocking ring, on top of said elongated shank,
whereby a wearer can easily and seamlessly assemble a personal customized ring by operating said interlocking means, thus easily interchanging said inner ring according to personal desire.

2. The ring system jewelry of claim 1 wherein said interlocking means is a thread interlocking mechanism consisting of an external thread on the second end of said elongated shank and a mating internal thread on the inner surface of said interlocking ring,
whereby said interlocking ring can be screwed onto and off of the second end of said shank.

3. The system of ring jewelry of claim 2 further including
at least one specific tool member in sufficient size to be comfortably and firmly held by a human fingers, wherein said tool is in part made from non-smooth, friction enhancing material, selected from the group consisting of rubber and silicon,
said specific tool is pressed against said interlocking ring thus providing firmer grip and control over said interlocking ring while handling said thread interlocking mechanism,
whereby the wearer is an active participant in customizing a personal ring assembly by using said specific tool for operating said thread interlocking mechanism.

4. The ring system jewelry of claim 2 wherein either one or both of said fixed flange ring and said interlocking ring has a ring engaging structure selected from the group consisting of indents, holes and protrusions construed on the outer surface of said flange ring and said interlocking ring.

5. The ring system jewelry of claim 4 further including
at least one specific tool member in sufficient size to be comfortably and firmly held by human fingers, having a mating tool engaging structure selected from the group consisting of indents, holes and protrusions which correspond said ring engaging structures,
said specific tool is engaged to said ring engaging structure, thus providing an easier, stronger and more secure handling of said thread interlocking mechanism,
whereby the wearer is an active participant in customizing a personal ring assembly by using said specific tool for operating said thread interlocking mechanism.

6. The ring system jewelry of claim 1 wherein said interlocking means is a magnetic coupling wherein said interlocking ring is capable of magnetically coupling with the second end of said elongated shank.

7. The ring system jewelry of claim 1 wherein said interlocking ring having structurally and visually designed features.

8. The ring system jewelry of claim 1 wherein said fixed flange ring having structurally and visually designed features.

9. The ring system jewelry of claim 1 wherein said inner ring having structurally and visually designed features.

10. The ring system jewelry of claim 1 further including a plurality of said inner ring.

11. A ring system jewelry including a ring assembly comprising of
at least one interchangeable inner ring, having predetermined inner diameter,
an elongated shank member, with sufficient inner diameter that defines a finger receiving opening, having outer diameter smaller than the inner diameter of said inner ring,
two delimiting rings, having outer diameter bigger than the inner diameter of said inner ring, each encircling either end of said shank,
a means for short-term interlocking at least one of said delimiting rings with its corresponding end of said shank,
at least one of said delimiting rings is released from its corresponding end of said shank, providing said inner ring to slide over and to site on said shank,
at least one of said delimiting rings is interlocked to its corresponding end of said shank using said interlocking means, thus delimiting and sandwiching said inner ring between said two delimiting rings, on said shank.
whereby a wearer can easily and seamlessly assemble a personal customized ring by operating said interlocking means, thus easily interchanging said inner ring according to personal desire, and securely preventing said inner ring from sliding off said shank by sandwiching said inner ring in between said two delimiting rings.

12. The ring system jewelry of claim 11 wherein first of said two delimiting rings is structurally fixed to first end of said shank, thus only the second of said two delimiting rings has means for short-term interlocking with second end of said shank.

13. The ring system jewelry of claim 11 wherein both said delimiting rings have means for short-term interlocking with their corresponding end of said shank.

14. The ring system jewelry of claim 11 wherein said interlocking means is a thread interlocking mechanism, consisting of a thread on the undersurface of at least one of said delimiting rings and a mating external thread on the corresponding outer surface end of said shank,
whereby at least one of said interlocking rings can be screwed onto and off of its corresponding end of said shank.

15. The ring system jewelry of claim 14, wherein said delimiting rings have a ring engaging structure, selected from the group consisting of indents, holes and protrusions.

16. The ring system jewelry of claim 15 further including
at least one specific tool member in sufficient size to be comfortably and firmly held by a human fingers, having a mating tool engaging structure, selected from the group consisting of indents, holes and protrusions, corresponding to said ring engaging structure,
said specific tool is engaged to said ring engaging structure, thus providing an easier, stronger and more secure operation of said thread interlocking mechanism,
whereby the wearer has become an active participant in customizing a personal jewelry ring by using said specific tool for operating said thread interlocking mechanism.
